(19) United States
(12) Patent Application Publication
(10) Pub. No.: US 2012/0062397 A1
(43) Pub. Date: Mar. 15, 2012

(54) TRAFFIC INFERIOR TAG RECOGNIZATION BUS INFORMATION SYSTEM

(75) Inventor: Jin Jun KIM, Busan (KR)

(73) Assignee: BNGROTIS INC., Busan (KR)

(21) Appl. No.: 12/880,449

(22) Filed: Sep. 13, 2010

(51) Int. Cl. G08G 1/123; G10L 13/08

(52) U.S. Cl. 340/994; 704/260; 704/E13.011

(57) ABSTRACT

A traffic inferior tag recognition bus information system is disclosed. The traffic inferior tag recognition bus information system comprises a bus terminal for generating and transmitting a position information of the bus via a communication network, a traffic information center for receiving the position information via the communication network and generating a run information, and a station guide for receiving the run information corresponding with the station identification number. According to the traffic inferior tag recognition bus information system, the traffic inferiors such as the visually handicapped persons and illiterate persons can easily obtain the run information of the waiting bus.

### BACKGROUND

1. Field

The present invention relates to a traffic information system, and more particularly, to a bus information system for traffic inferior such as a visually handicapped person.

2. Description of the Related Art

There are some kinds of bus information systems in large cities. The bus information systems provide the run information of the buses which are driven the city. The bus information systems collect the position information of the buses in the city. And, the bus information systems generate the run information with arranging the position information of the buses according to the route. And then, the run information is provided to each of the station guides to display. Due to these bus information systems, the users can easily obtain the information such as the arriving time of the waiting bus.

However, in the conventional bus information system, the run information was displayed in the form of a statement data. So, it is difficult for the traffic inferiors, such as the visually handicapped persons and the illiterate persons, to obtain the run information of the waiting bus.

Therefore, it is needed to provide the bus information system that the traffic inferiors can easily obtain the run information of the waiting bus.

### SUMMARY OF THE INVENTION

The present invention is directed to the bus information system that even the traffic inferiors can easily obtain the run information.

According to an aspect of the present invention, there is provided a traffic inferior tag recognition bus information system. The traffic inferior tag recognition bus information system comprises a bus terminal for generating and transmitting a position information of the bus via a communication network, the bus terminal being located in the bus; a traffic information center for receiving the position information via the communication network, and generating a run information, wherein the run information is based on the position information and a station identification number; and a station guide for receiving the run information corresponding with the station identification number, wherein the station guide is located in a bus station corresponding to the station identification number. The station guide includes a central communication module for receiving a run information corresponding to the station identification number via the communication network; a tag reader module for reading a traffic inferior tag within a reference distance; a data processing portion for generating a statement data based on the run information, and converting the statement data into the voice data with responding to the recognition of the traffic inferior tag; a statement display portion for displaying the statement data; and a voice output portion for outputting the voice data.

According to the traffic inferior tag recognition bus information system of the present invention, the traffic inferiors such as the visually handicapped persons and illiterate persons can easily obtain the run information of the waiting bus.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a drawing of a traffic inferior tag recognition bus information system according to an embodiment of the present invention;

FIG. 2 is a drawing for explaining the structure of run information and a traffic inferior tag;

FIG. 3 is a drawing for explaining the generation of the voice data;

FIG. 4 is a diagram illustrating the station guide 300 of FIG. 1 in detail;

FIG. 5 is a diagram illustrating the data processing portion of FIG. 4 in more detail; and

FIG. 6 is a flowchart for explaining the outputting process of the statement data and the voice data in the station guide.

### DETAILED DESCRIPTION OF EMBODIMENTS

The foregoing and other objects, features, and advantages of the invention are apparent from the following detailed description taken in conjunction with the accompanying drawings.

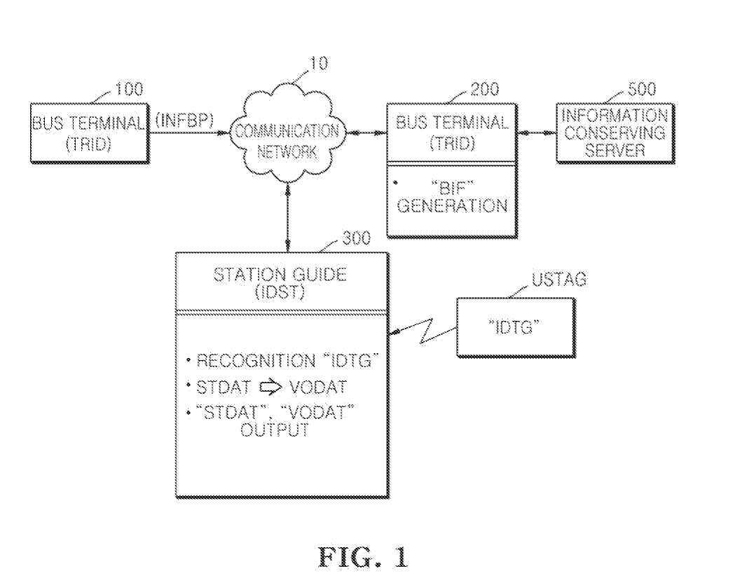

Referring to FIG. 1, the traffic inferior tag recognition bus information system of the present invention collects the position information INFBP of the buses running the regular route via a communication network 10, and generates the run information BIF based on the position information INFBP of the buses. And then, the run information BIF is provided to a station guide 300 in real time.

In the traffic inferior tag recognition bus information system of FIG. 1, a bus terminal 100, a traffic information center 200 and the station guide 300 are included.

The bus terminal 100 is located in a bus. And, a terminal identification number TRID is given to the bus terminal 100. With the terminal identification number TRID, the bus having the bus terminal 100 can be checked. Also, the bus terminal 100 generates the position information INFBP of the bus. And, the position information INFBP is provided to the communication network 10.

Meanwhile, the position information INFBP of the bus can be caught by a positioning system such as GPS. Here, the GPS is well known to those skilled in the art. Therefore, the detailed description is omitted for the simplicity of this specification.

The traffic information center 200 receives the terminal identification number TRID and the position information INFBP of the bus. The terminal identification number TRID and the position information INFBP are provided from the bus terminal 100 via the communication network 10. And, the traffic information center 200 generates the run information BIF applicable to the station guide 300. Here, the run information BIF is based on the terminal identification number TRID and a station identification number IDST. That is, the run information BIF is applicable to the station identification number IDST. And, the run information BIF is provided to the station guide 300 corresponding to the station identification number IDST via the communication network 10.

Preferably, the run information BIF includes the arriving information of the bus. That is, the arriving time of the waiting bus is included in the run information BIF.

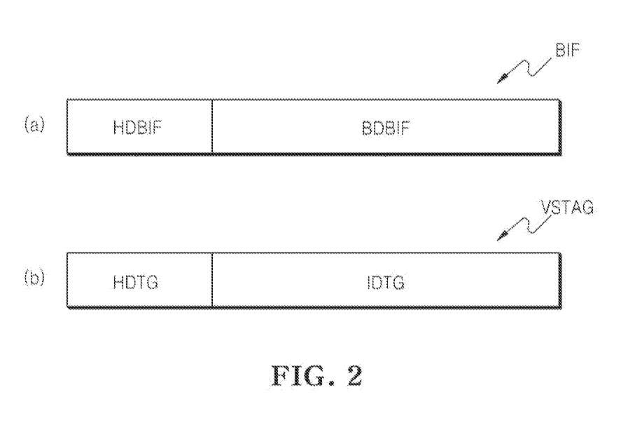

For example, the run information BIF is consisted of an information head HDBIF and an information body BDBIF, as shown in the top of FIG. 2.

The station guide 300 is located in the bus station corresponding to the station identification number IDST. The station guide 300 receives the run information BIF via the communication network 10. And, the station guide 300 generates a statement data STDAT based on the run information BIF. At this time, the statement data STDAT may be the information body BDBIF of the run information BIF. Also, the statement data STDAT may be generated from the information body BDBIF.

And, the station guide 300 converts the statement data STDAT into a voice data VODAT, when a traffic inferior tag USTAG is recognized. And, the station guide 300 displays the statement data STDAT, and outputs the voice data VODAT.

The traffic inferior tag USTAG is attached on or possessed by the traffic inferior using the bus information system of the present invention. The traffic inferior tag USTAG can include the information for the traffic inferior. Preferably, the traffic inferior tag USTAG is consisted of a tag head HDTG and a tag identification number IDTG, as shown in the bottom of FIG. 2.

The tag head HDTG indicates the traffic inferior tag USTAG. The tag identification number IDTG may be in the form of serial number. With the tag identification number IDTG, the personal identity of user may be checked.

Preferably, the traffic inferior tag USTAG is a type of a local communication tag. More preferably, the traffic inferior tag USTAG is RFID type.

In the present invention, the tag head HDTG and the tag identification number IDTG of the traffic inferior tag USTAG are read without contact. Accordingly, the position of the traffic inferior can be easily checked.

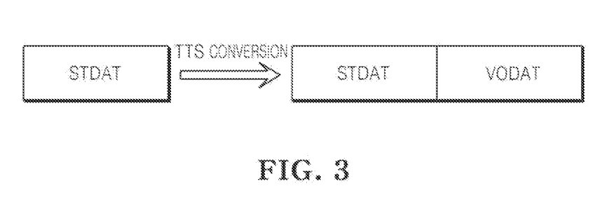

As shown in FIG. 3, TTS conversion method may be used to generate the voice data VODAT from the statement data STDAT. The TTS conversion method is well known to those skilled in the art. So, the detailed description is omitted for the simplicity of this specification.

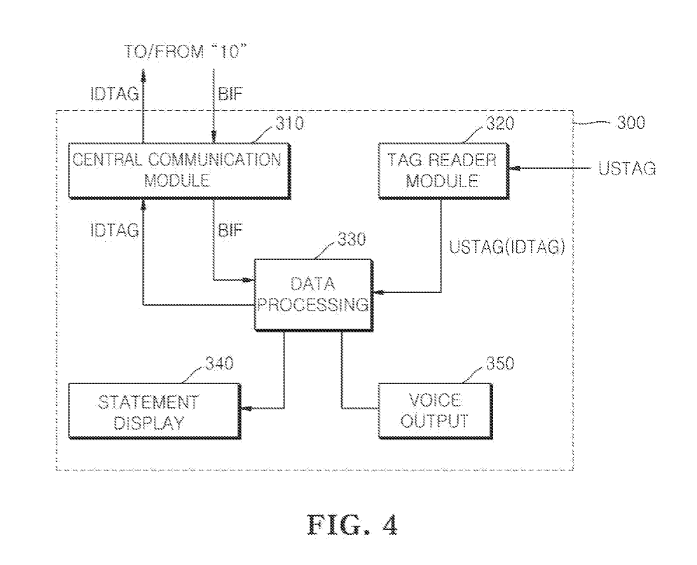

Referring to FIG. 4, the station guide 300 includes a central communication module 310, a tag reader module 320, a data processing portion 330, a statement display portion 340 and a voice output portion 350.

The central communication module 310 communicates with the communication network 10. The central communication module 310 receives the run information BIF of the station guide 300 corresponding to the station identification number IDST. Also, the central communication module 310 provides the information of the traffic inferior tag USTAG, which is recognized by the station guide 300, to the traffic information center 200, via the communication network 10.

The tag reader module 320 reads the traffic inferior tag US TAG within a reference distance. Preferably, the reference distance is 4 m-10 m.

According to the preferable embodiment of the present invention, the traffic inferior tag USTAG reflects RF signal transmitted from the tag reader module 320. At this time, the tag identification number IDTG of the traffic inferior tag USTAG is included in the reflected the RF signal.

Meanwhile, the tag reader module 320 communicates with the data processing portion 330.

The data processing portion 330 processes the information which is read at the tag reader module 320. The data processing portion 330 generates the statement data STDAT based on the run information BIF. And, the data processing portion 330 generates the voice data VODAT corresponding to the statement data STDAT, when the traffic inferior tag USTAG is recognized by the tag reader module 320.

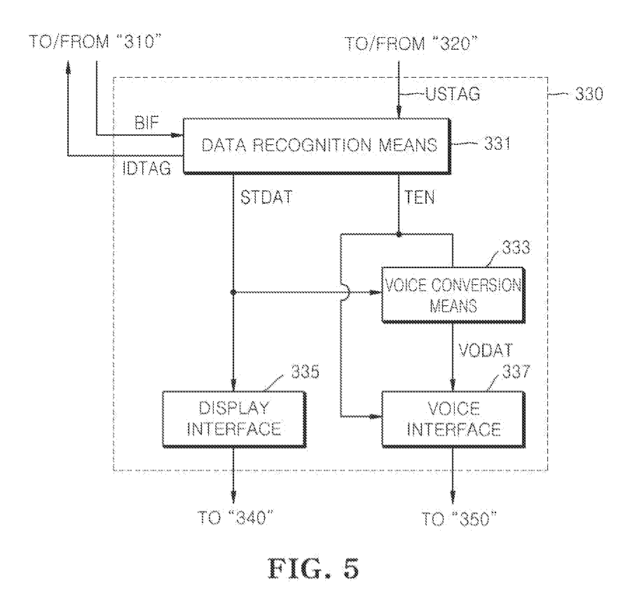

Referring to FIG. 5, the data processing portion 330 includes a data recognition means 331, a voice conversion means 333, a display interface 335 and a voice interface 337.

The data recognition means 331 receives the run information BIF from the central communication module 310, and receives the information of the traffic inferior tag USTAG from the tag reader module 320. Also, the data recognition means 331 generates the statement data STDAT based on the run information BIF. The data recognition means 331 generates a conversion enable signal TEN. At this time, the conversion enable signal TEN is activated with responding to the run information BIF, which is received after the traffic inferior tag USTAG is recognized.

The data recognition means 331 provides the tag identification number IDTG of the traffic inferior tag USTAG to the central communication module 310.

The voice conversion means 333 is enabled with responding to the activation in the conversion enable signal TE. And, the voice conversion means 333 generates the voice data VODAT corresponding to the statement data STDAT.

The display interface 335 provides the statement data STDAT to the statement display portion 340. The voice interface 337 provides the voice data VODAT to the voice output portion 350 with responding to the conversion enable signal TEN.

Therefore, when the voice data VODAT is generated, the voice interface 337 is enabled. The voice output portion 350 receives the voice data VODAT with almost same timing.

Again referring to FIG. 4, the statement display portion 340 displays the statement data STDAT. The voice output portion 350 outputs the voice data VODAT.

Preferably, the statement display portion 340 is implemented with LCD panel.

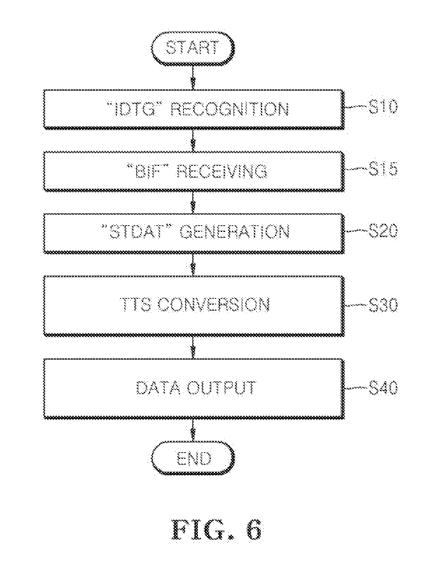

Referring to FIG. 6, the traffic inferior tag USTAG is recognized, at the step of S10. The run information BIF is received, at the step of S15. The statement data STDAT is generated, at the step of S20. Also, at the step of S30, the statement data STDAT is converted to the voice data VODAT.

At the step of S40, the statement data STDAT is displayed, and the voice data VODAT is output. According to the present invention, the voice data VODAT is output as well as the statement data STDAT.

Therefore, the traffic inferiors, such as the visually handicapped persons and illiterate persons, can easily obtain the run information of the waiting bus from the station guide 300.

Again referring to FIG. 1, the traffic inferior tag recognition bus information system of the present invention further includes an information conserving server 500. The information conserving server 500 conserves the information in the traffic inferior tag USTAG received via the communication network 10.

For example, the tag identification number IDTG of the traffic inferior tag USTAG and the station identification number IDST are conserved in the information conserving server 500.

Accordingly, with the tag identification number IDTG of the traffic inferior tag USTAG and the station identification number IDST are conserved in the information conserving server 500, the traveling route of the traffic inferior is easily checked.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A traffic inferior tag recognition bus information system, comprising:
a bus terminal for generating and transmitting a position information of the bus via a communication network, the bus terminal being located in the bus;
a traffic information center for receiving the position information via the communication network, and generating a run information, wherein the run information is based on the position information and a station identification number; and
a station guide for receiving the run information corresponding with the station identification number, wherein the station guide is located in a bus station corresponding to the station identification number,
wherein the station guide includes
a central communication module for receiving a run information corresponding to the station identification number via the communication network;
a tag reader module for reading a traffic inferior tag within a reference distance;
a data processing portion for generating a statement data based on the run information, and converting the statement data into the voice data with responding to the recognition of the traffic inferior tag;
a statement display portion for displaying the statement data; and
a voice output portion for outputting the voice data.

2. The system of claim 1, wherein the data processing portion comprises:
a data recognition means for recognizing the traffic inferior tag to a conversion enable signal, wherein the conversion enable signal is activated with responding to the run information received after the traffic inferior tag is recognized;
a voice conversion means for converting the statement data to the voice data, the voice conversion means being enabled with responding to the conversion enable signal;
a display interface for providing the statement data to the statement display portion; and
a voice interface for providing the voice data to the voice output portion with responding to the conversion enable signal.

3. The system of claim 1, wherein the traffic inferior tag includes a tag identification number,
wherein the central communication module provides the information of the traffic inferior tag via the communication network,
wherein the station guide further includes
an information conserving server for conserving the information of the traffic inferior tag and the station identification number.

4. The system of claim 1, wherein the traffic inferior tag is a type of a local communication tag.

5. The system of claim 4, wherein the traffic inferior tag is RFID type.
